(19) United States
(12) Patent Application Publication
(10) Pub. No.: US 2023/0349449 A1
(43) Pub. Date: Nov. 2, 2023

(54) TENSIONER ADJUSTER

(71) Applicant: GATES CORPORATION, Denver, CO (US)

(72) Inventor: Rafael Rodrigues Fortes, Jacarei, Sao Paulo (BR)

(21) Appl. No.: 18/025,607

(22) PCT Filed: Sep. 13, 2021
(86) PCT No.: PCT/US2021/050106

§ 371 Date: Mar. 9, 2023

Related U.S. Application Data
(60) Provisional application No. 63/078,261, filed on Sep. 14, 2020.

(51) Int. Cl. F16H 7/12

(52) U.S. Cl. CPC F16H 7/1218; F16H 2007/081

(57) ABSTRACT

A tensioner adjuster includes a plate portion with an opening for receiving a fastener during installation of a tensioner. The tensioner adjuster further includes a first curved neck portion extending from the plate portion and a first guide portion extending from the first curved neck portion with a fastener engaging member to engage the fastener. The tensioner adjuster further includes a second curved neck portion extending from the plate portion on a side of the plate portion opposite from the side of the plate portion from which the first curved neck portion extends and a second guide portion extending from the second curved neck portion with a fastener engaging member to engage the fastener.

### BACKGROUND

### Field of the Disclosure

The present invention relates to tensioners, and more specifically, belt tensioners having adjusters for easily and precisely installing the tensioners in operative relation with a belt, such as a timing or drive belt.

### Description of Related Technology

Belt tensioners have been utilized in many belt systems. It is conventional practice in belt tensioners to apply a constant belt tensioning force which compensates for increases in belt length due to wear and other factors. A common type of conventional belt tensioner includes a fixed structure and a pivoted structure pivotally mounted on the fixed structure by a pivot assembly. The pivoted structure carries a belt-engaging pulley. A coil or torsion spring is mounted in surrounding relation to the pivot assembly and has its ends connected between the fixed and pivoted structures so as to bias the latter toward a position of maximum belt take-up so that the spring biasing force decreases as the pivoted structure moves from a position of minimum take up to a position of maximum belt take-up. Despite this varying spring force within the range of movement provided, a substantially constant belt tension is maintained.

When belt tensioners are installed on an engine they should be installed so as to apply a predetermined static tensioning force to the belt. In addition, the pivoted structure, which conventionally carries the pulley, is movable between two positions defined by end stops. During the adjustment or installation of the tensioner, an adjusting member or an eccentric adjusting member, which forms part of the fixed structure, is adjusted to move the pivoted structure into a position between the stops, wherein the belt tensioning pulley is disposed in a predetermined static tensioning relation to the belt.

Many adjusters for tensioners are manufactured as a two-piece construction, for example, in an injection molded, die cast or stamped process. The two-piece manufacturing process can be costly and time-consuming due to, for example, the re-tooling efforts that are needed when manufacturing different sized eccentric adjusters and different sized eccentric tensioners. What is needed is a tensioner adjuster that can be more economically and sustainably manufactured for a variety of differently sized eccentric adjusters and tensioners.

### SUMMARY

In one embodiment of the present disclosure a tensioner includes a base, a sleeve having a bore and connected to the base, an arm pivotally engaged with the base about the sleeve, a pulley journaled to the arm, a torsion spring engaged between the arm and the base, and an adjuster. The adjuster is rotatably mounted within the center bore of the sleeve and includes: a plate portion having an opening for receiving a fastener, a first neck portion extending from the plate portion, a first guide portion extending from the first neck portion with a fastener engaging member for engaging the fastener, a second neck portion extending from the plate portion on a side of the plate portion opposite from the side of the plate portion from which the first neck portion extends, and a second guide portion extending from the second neck portion with a fastener engaging member for engaging the fastener.

In another embodiment of the present disclosure, a tensioner adjuster includes a plate portion having an opening for receiving a fastener, a first curved neck portion extending from the plate portion, a first guide portion extending from the first curved neck portion with a fastener engaging member for engaging the fastener. The tensioner further includes a second curved neck portion extending from the plate portion on a side of the plate portion opposite from the side of the plate portion from which the first curved neck portion extends, and a second guide portion extending from the second curved neck portion with a fastener engaging member for engaging the fastener.

In yet another embodiment of the present disclosure, a tensioner adjuster includes a plate portion having an opening for receiving a fastener for installation of a tensioner, a first curved neck portion extending from the plate portion, and a first guide portion extending from the first curved neck portion with a fastener engaging member constructed and arranged to engage the fastener. The tensioner further comprises a second curved neck portion extending from the plate portion on a side of the plate portion opposite from the side of the plate portion from which the first curved neck portion extends, and a second guide portion extending from the second curved neck portion with a fastener engaging member constructed and arranged to engage the fastener. The tensioner further includes a first reinforcing support that extends from the first curved neck portion, a second reinforcing support that extends from a side of the first curved neck portion that is opposite the side from which the first reinforcing support extends, a third reinforcing support that extends from a side of the second curved neck portion, and a fourth reinforcing support that extends from a side of the second curved neck portion that is opposite the side of the second curved neck portion from which the third reinforcing support extends.

Other aspects of the invention will be explained or made obvious by the following description of the invention and the accompanying drawings.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of an embodiment of a tensioner with an adjuster of the present disclosure.

FIG. 2 is another perspective view of an embodiment of the tensioner with an adjuster of the present disclosure.

FIG. 3 is a top plan view of an embodiment of the tensioner with an adjuster of the present disclosure.

FIG. 4 is a cross-sectional view of an embodiment of the tensioner with an adjuster of the present disclosure taken along lines A-A of FIG. 3.

FIG. 5 is an exploded view of an embodiment of the tensioner with an adjuster of the present disclosure.

FIG. 6 is a perspective view of an embodiment of the adjuster for the tensioner of the present disclosure.

FIG. 7 is another perspective view of an embodiment of the adjuster for the tensioner of the present disclosure.

FIG. 8 is another perspective view of an embodiment of the adjuster of the present disclosure after being stamped and prior to forming the adjuster into the structure of the adjuster for use in installing the tensioner of the present disclosure.

FIG. 9 is a top view of an embodiment of the adjuster for the tensioner of the present disclosure.

FIG. 10 is a bottom view of an embodiment of the adjuster for the tensioner of the present disclosure.

FIG. 11 is a left side view of an embodiment of the adjuster for the tensioner of the present disclosure.

FIG. 12 is a right side view of an embodiment of the adjuster for the tensioner of the present disclosure.

FIG. 13 is a front side view of an embodiment of the adjuster for the tensioner of the present disclosure.

FIG. 14 is a back side of an embodiment of the adjuster for the tensioner of the present disclosure.

### DETAILED DESCRIPTION

The tensioner adjuster of the present disclosure comprises an eccentric adjuster. The eccentric adjuster may be used to move a tensioner into proper engagement with a belt during installation. The eccentric adjuster may be manufactured by stamping a single piece of material, e.g., a sheet metal material, and forming the single piece of stamped material into an adjuster structure that assists in the installation of a belt tensioner, for example, onto a motor vehicle engine by moving the pivoted structure into a position between stops in which the belt tensioning pulley is placed into predetermined static tensioning relation to the belt. The process of stamping the adjuster material into a single piece and forming the single piece of stamped material into the adjuster structure enables eccentric adjusters to be manufactured with different sizes for use with different sized eccentric tensioners, without requiring tooling changes during manufacturing. The adjusters of the present disclosure are accordingly made without expensive and time-consuming re-tooling efforts during manufacturing, which substantially reduces per unit adjuster manufacturing costs. The reduction in re-tooling during manufacturing not only provides significant economic benefits, but also creates a more environmentally sustainable manufacturing process.

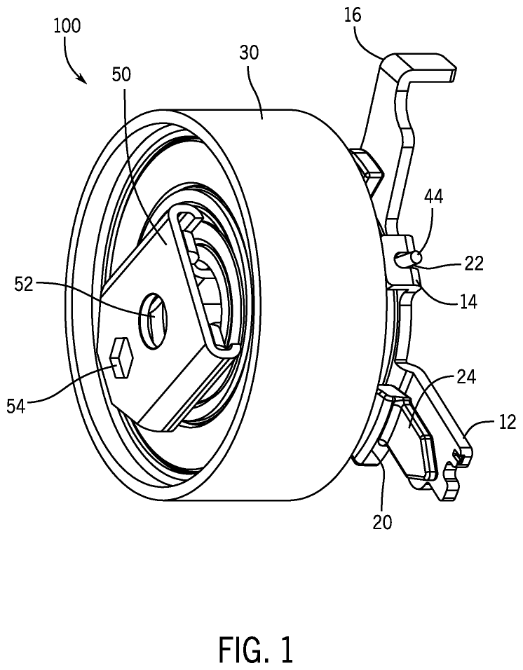

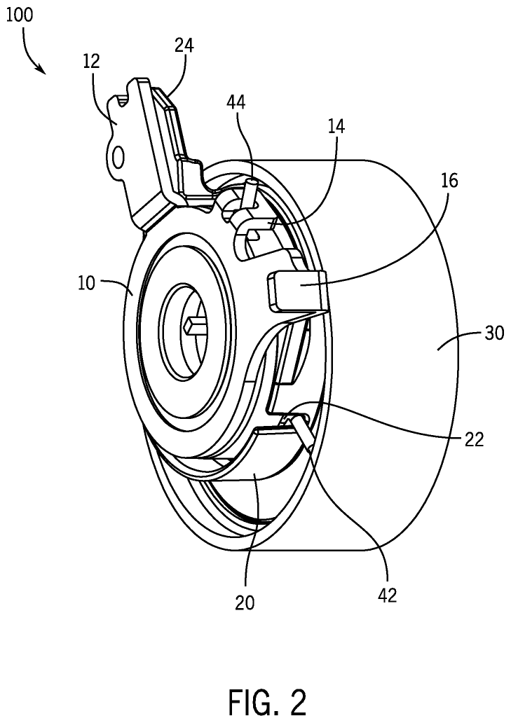

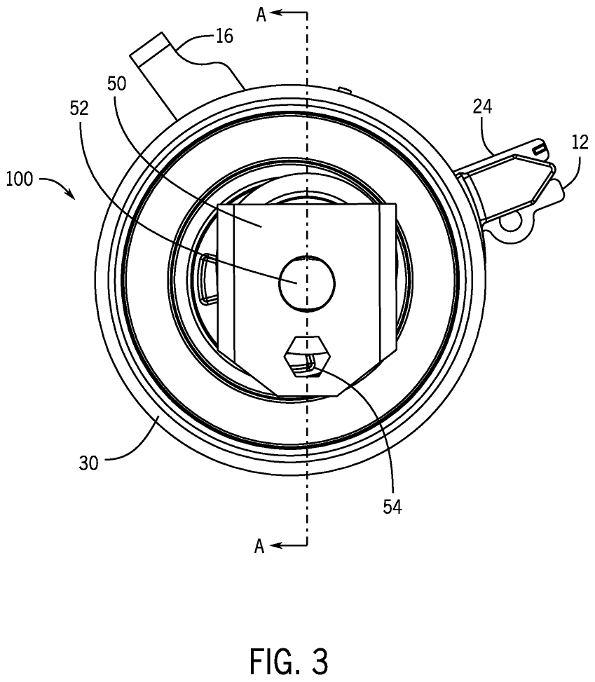

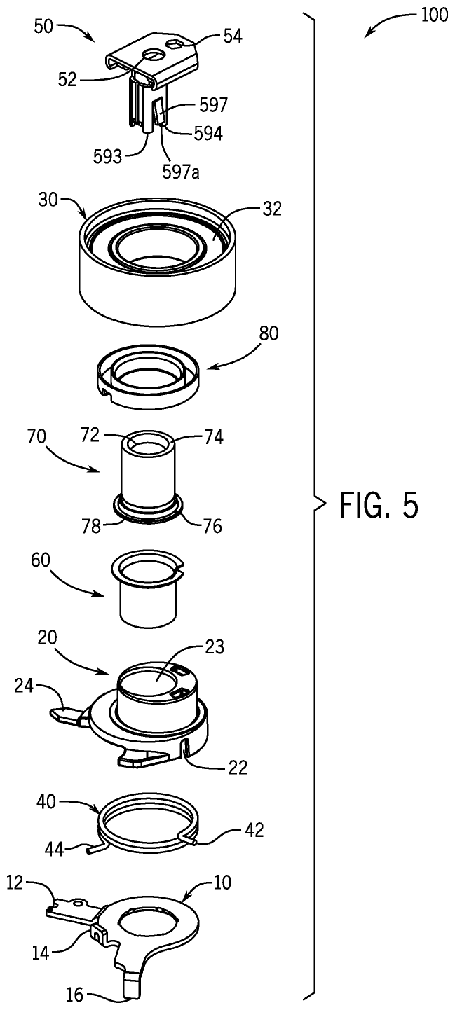

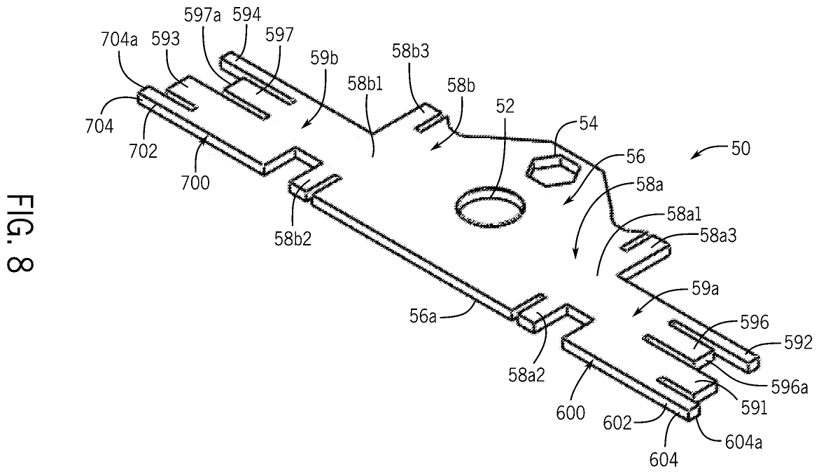

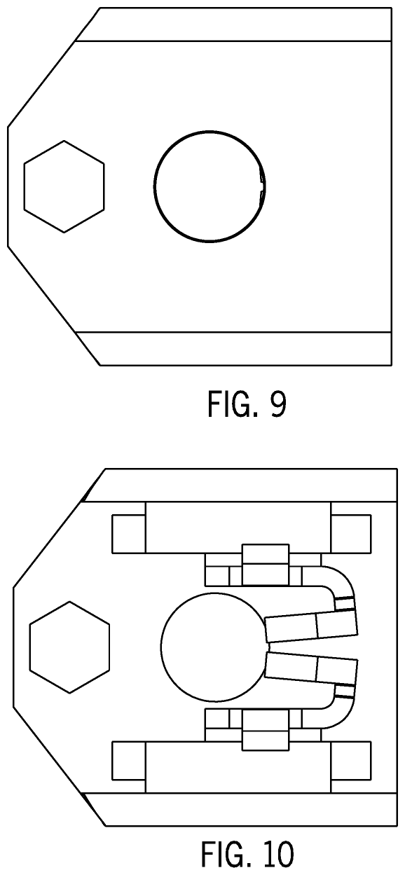

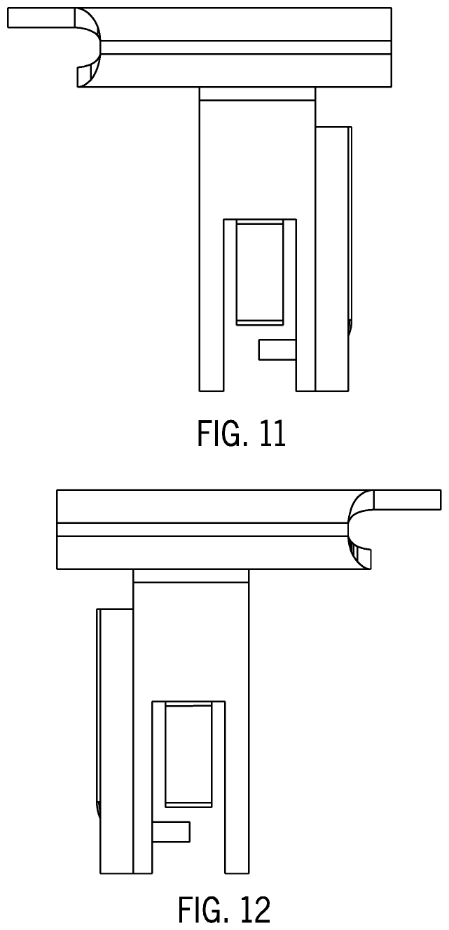

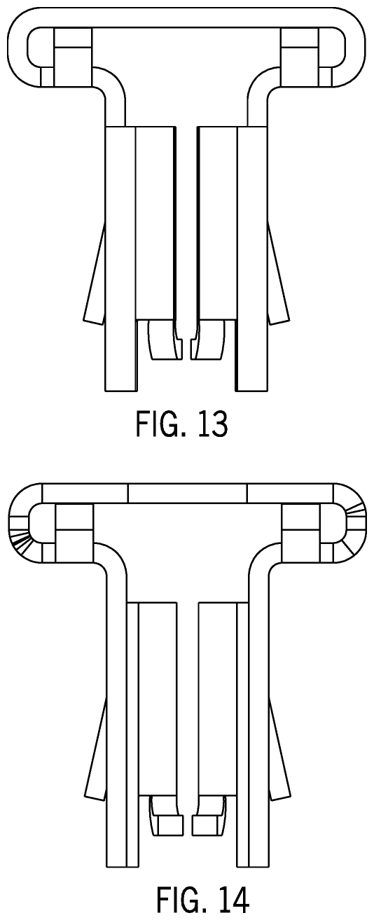

FIGS. 1-14 illustrate a tensioner 100 with a one-piece adjuster 50 according to an embodiment of the present disclosure. Tensioner 100 comprises an adjuster 50 that is eccentric and used to move tensioner 100 into proper engagement with a belt during installation, for example, during the installation of tensioner 100 onto a motor vehicle engine, as discussed herein. It should be appreciated from the foregoing that FIGS. 9-14 illustrate the same adjuster embodiment illustrated in FIGS. 1-8.

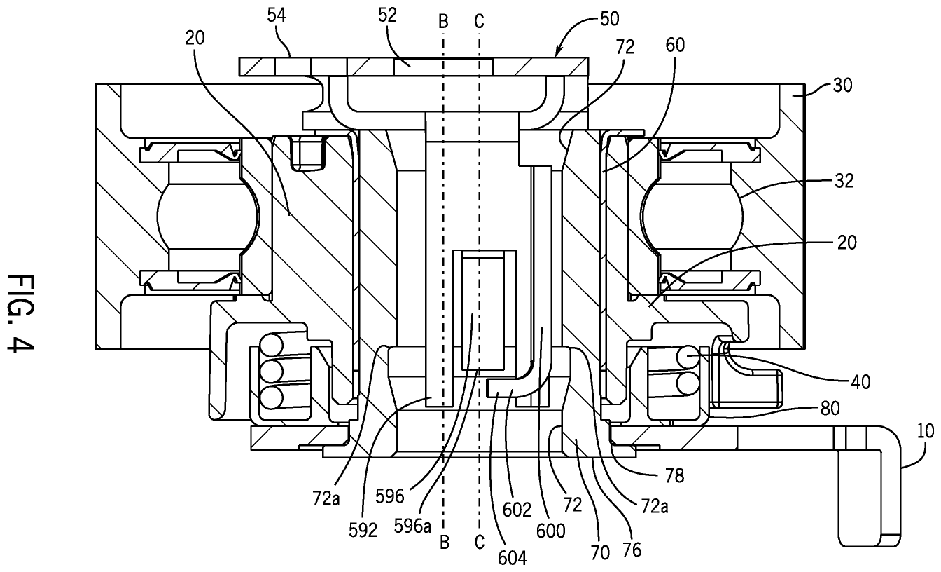

During installation, adjuster 50 is rotated about a fastener, such as a bolt or stud or any other suitable fastener (fastener not shown), that passes through an opening 52 defined in adjuster 50. When the fastener extends through opening 52, the fastener is engaged with, or guided or held in place by, engaging members 600, 700 (of respective first and second guide portions 59a, 59b of adjuster 50 as discussed below). The fastener inserted into opening 52 extends to a distal end of tensioner 100 where the fastener secures tensioner 100 to, for example, a motor vehicle engine. The center of the fastener that extends through opening 52 and is guided or held by the first and second engaging members 600, 700 defines an axis of rotation B-B for the fastener (See, FIG. 4). Axis B-B is eccentrically offset from an axis of rotation of pulley 30 C-C(See, FIG. 4), and is eccentrically offset from an axis of rotation of the pivotal arm 20 of tensioner 100 (the axis of rotation for arm 20 is unlabeled). Eccentric adjuster 50 is used to precisely load a belt (not show) that is engaged with pulley 30 with a predefined tension by compensating for all component tolerances. Adjuster 50 is used during belt installation and locked in place once the belt is installed by fully engaging the fastener with a mounting surface, for example, with motor vehicle engine. Eccentric in the term eccentric adjuster 50 refers to the axis of fastener rotation B-B not being coaxial with the axis of rotation C-C of a pulley 30 or with the axis of rotation of arm 20, which is defined by another axis (unlabeled) that is substantially parallel to axis B-B.

Pulley 30 engages a belt to provide belt tension or load. Pulley 30 is journalled to arm 20 about a bearing or bearing assembly 32. Pulley 30 is engaged with an outer race of bearing 32. Bearing 32 comprises a ball bearing but may comprise a needle bearing or any other suitable bearing.

Arm 20 comprises or has a center bore or opening 23 defined therein. Arm 20 is biased by a coil or torsion spring 40 to urge pulley 30 into the belt (not shown). Arm 20 pivots about sleeve 70 about a bushing 60. Bushing 60 allows arm 20 to rotate smoothly about sleeve 70 and contributes to friction damping. Bushing 60 may comprise a low friction material for facilitating the relative movement of arm 20, e.g., a material comprising brass, copper and sintered metal. The pivotal movement of arm 20 about sleeve 70 results in a translational movement of pulley 30 that allows tensioner 100 to compensate for any changes in belt length as the belt stretches over time and as the drive length changes from thermal expansion.

Arm 20 is engaged with an inner race of bearing 32. Pulley 30 is pressed into engagement against the belt by a torsion spring 40. A first end or arm engaging end 42 of torsion spring 40 is engaged with a slot 22 defined in arm 20. A second opposite end or base engaging end 44 of torsion spring 40 is engaged with base 10 in a slot (not labeled) defined in a spring engaging member 14 of base 10.

Base 10 is statically fixed during installation of tensioner 100 to a mounting surface, such as an engine of a motor vehicle (not shown). Spring torque from torsion spring 40 and the effective arm length of arm 20 creates a belt load or tension. Tang 16 of base 10 engages a cooperating receiving member on the mounting surface such as a hole in the mounting surface (not shown) and is used to prevent rotation of base 10 during installation of tensioner 100. While base 10 is used to mount tensioner 100, base 10 is also used to secure an end of the torsion spring 40, e.g., to secure base engaging end 44 of torsion spring 40 in a slot defined in spring engaging member 14 of base 10.

Sleeve 70 is attached or fixed to base 10, e.g., via a mechanical interference fit, and is generally or substantially cylindrically shaped having a bore 72 defined therein. Sleeve 70 and its bore extend from a distal end 76 of sleeve 70 to a proximal end 74 of sleeve 70. Distal end 76 of sleeve 70 comprises a circumferential collar 78. Sleeve 70 further comprises a shoulder 72a that extends circumferentially around, and is defined by, an interior or inside wall of the bore 72 defined in sleeve 70 (See FIG. 4 showing shoulder 72a of sleeve 70).

A damper 80 is mounted to sleeve 70 and arranged in tensioner 100 between base 10 and arm 20 to act as a damping control member. Damper 80 is held axially by sleeve 70 and is rotationally fixed by, for example, spring 40 being inserted through a slot or opening in the damper 80 that may align rotationally with the slot defined in the spring engaging member 14 of base 20. Damper 80 controls and reduces oscillations of arm 20 during operation and may comprise and material suitable for reducing and controlling oscillations of arm 20.

Arm 20 comprises an arm indicator 24 that cooperates with a base indicator 12 of base 10 to display when tensioner 100 is properly installed and loaded during installation. Pulley 30 comprises a belt engaging surface (not labeled), which may be flat as shown, or any other suitable shape or profile for engaging a belt.

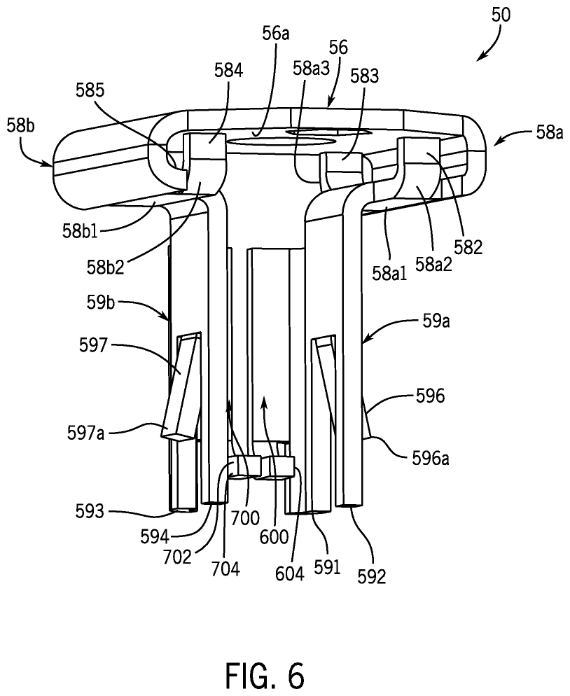

Referring now more specifically to an embodiment of a one-piece adjuster of the present disclosure, FIGS. 1-14 illustrate one embodiment of a tensioner 100 having an adjuster 50, and one embodiment of the adjuster 50 isolated by itself for use with a tensioner, such as tensioner 100. In particular, FIGS. 6-14 illustrate adjuster 50 isolated from tensioner 50 but for use with a tensioner such as tensioner 100. Adjuster 50 may be manufactured by stamping a single piece of material, e.g., a single piece of sheet metal material, into a substantially flat one-piece structure such as the structure illustrated in FIG. 8. The substantially flat one-piece stamped adjuster material may then be formed into an adjuster structure, such as the structure of adjuster 50 illustrated in FIGS. 1, 3-7, and 9-14 by, for example, folding the stamped adjuster material using a rolling process. The adjuster 50 as formed comprises a substantially planar plate portion 56 and first and second opposing guide portions 59a, 59b. First and second guide portions are connected to opposing sides of planar plate portion 56 via first and second neck portions 58a, 58b, respectively. First and second guide portions 59a, 59b further comprise first and second engaging members 600, 700, respectively, each of which is constructed and arranged to engage the fastener, such as the bolt or stud (as discussed above), when the fastener is inserted into adjuster 50 for rotation about axis B-B during installation of tensioner 100.

Plate portion 56 comprises, or defines therein, a tool receiving portion 54. During installation, a tool, such as an Allen wrench (not shown), may be inserted or engaged at tool receiving portion 54 of adjuster 50 for rotating adjuster 50 about the fastener. Adjuster 50 may be rotated about the fastener that is inserted through opening 52 of plate portion 56. The fastener extends past opening 52 substantially perpendicular to plate portion 56 to a distal end of tensioner 100, where the fastener secures or mounts the tensioner to, for example, a motor vehicle engine. The fastener portion that extends beyond opening 52 is engaged with first and second fastener engaging members 600, 700 of first and second guide members 59a, 59b, respectively, as discussed below.

First neck portion 58a is formed so as to be curved or bent into a structure that is substantially or generally U-shaped with a parallel section 58a1 of the U-shape extending substantially or generally radially inwardly and substantially parallel to plate portion 56. Extending from opposing sides of parallel section 58a1 are first and second reinforcing supports 58a2, 58a3, respectively, each of which is formed so as to be curved or bent with sections 582, 583 that extend generally parallel to axis B-B (or the axis of bore 72 defined in sleeve 70) and perpendicular to plate portion 56 towards an underside or proximal surface 56a of plate portion 56. Sections 582, 583 of reinforcing supports 58a2, 58a3 each extend to the underside or proximal surface 56a without physically contacting surface 56a.

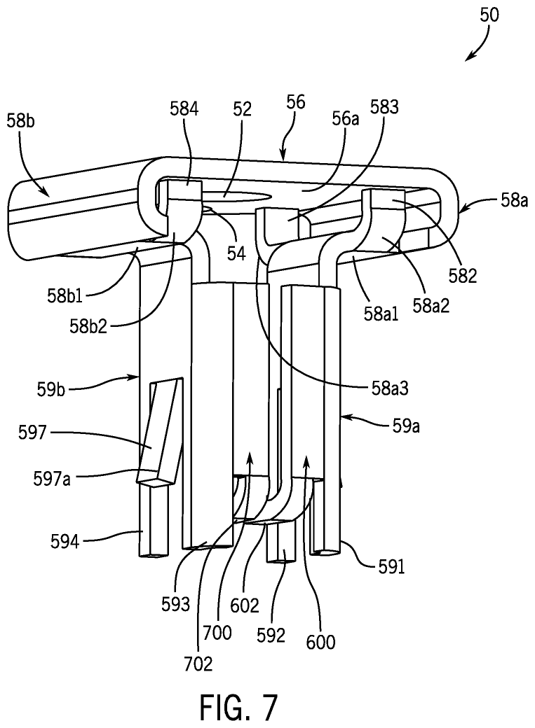

Similar to first neck portion 58a, second neck portion 58b is formed so as to be curved or bent into a structure that is substantially or generally U-shaped with a parallel section 58b1 of the U-shape extending substantially or generally radially inwardly and substantially parallel to plate portion 56. Extending from opposing sides of parallel section 58b1 are first and second reinforcing supports 58b2, 58b3, respectively, each of which is formed so as to be curved or bent with sections 584, 585 that extend generally parallel to axis B-B (or the axis of bore 72 defined in sleeve 70) and perpendicular to plate portion 56 towards the underside or proximal surface 56a of plate portion 56. It should be appreciated and understood that while reinforcing support 58b3 is shown in the adjuster figure of FIG. 8, reinforcing support 58b3 is obscured and not fully shown in FIGS. 6 and 7, but is located in FIGS. 6 and 7 in a position opposite 58b2 similar to reinforcing support 58a3 of first neck portion 58a, which is clearly shown in FIGS. 6 and 7. Sections 584, 585 of reinforcing supports 58b2, 58b3 each extend to the underside or proximal surface 56a without physical contacting surface 56a. When adjuster 50 is rotated during installation, a relatively high torque is applied by the head of the fastener (e.g., a bolt head) to the adjuster 50, e.g., in the range of 30-50 N·m. This high torque imparts a force to adjuster plate portion 56, which may cause plate portion 56 to mechanically deform, e.g., deform or bend in a generally downwardly direction from the perspective of looking through opening 52 from a topside surface of plate 56 along the axis of rotation B-B towards the distal end of adjuster 50. Such deformation can cause adjuster 50 to perform poorly resulting in improper tensioning of tensioner 100 during its installation and even leading to breakage or failure of plate portion 56. Reinforcing supports 58a1, 58a2, 58b2, 58b3 act to reduce or eliminate such mechanical deformation that may occur to adjuster plate portion 56 when such torque is applied during installation, thereby improving the quality, effectiveness and durability of adjuster 50 and of tensioner 100 having adjuster 50.

First and second guide portions 59a, 59b are integral with, and extend generally longitudinally from, first and second neck portions 58a, 58b, respectively, and are generally perpendicular to plate portion 56 and parallel to axis B-B. First guide portion 59a comprises two legs 591, 592 extending longitudinally and substantially perpendicular to plate portion 56 and substantially parallel to axis B-B. Positioned between legs 591, 592 is a sleeve engaging tab 596 that extends generally radially outwardly from axis B-B to a distal end portion 596a of tab 596. Distal end portion 596a extends radially outwardly to engage the shoulder 72a of sleeve 70. Shoulder 72a extends circumferentially around, and is defined by, an interior or inside wall of the bore 72 defined in sleeve 70 (See FIG. 4 showing shoulder 72a of sleeve 70).

Second guide portion 59b, which is opposite first guide portion 59a, comprises two legs 593, 594, which like legs 591, 592 of first guide portion 59a, extend generally longitudinally and substantially perpendicular to plate portion 56 and substantially parallel to axis B-B. Positioned between legs 593, 594 is a sleeve engaging tab 597 that extends generally radially outwardly from bolt axis B-B to a distal end portion 597a of tab 597. Distal end portion 597a extends radially outwardly to engage the shoulder 72a of sleeve 70. Sleeve engaging tabs 596 and 597 and their respective distal end portions 596a, 597a engaging sleeve shoulder 72a act to lock or engage adjuster 50 with sleeve 70 so that adjuster 50 can be secured or held axially in place during transport and assembly, e.g., assembly onto a motor vehicle engine. In an embodiment, sleeve engaging tabs 596 and 597 may be formed so as to be flexible and biased radially outwardly to engage and lock adjuster 50 with sleeve 70 so that adjuster 50 can be secured or held in place during transport and assembly, e.g., onto a motor vehicle engine. It should be appreciated that in certain embodiments, an outside diameter defined by a substantially circular shape drawn around, and defined by, the outside surface of legs 591, 592, 593, 594 may be slightly less than an inside diameter of the bore 72 of sleeve 70 so that legs 591, 592, 593, 594 of first and second guide member 59a, 59b may be inserted into and rotatable within bore 72 of sleeve 70.

First guide portion 59a further comprises a fastener engaging member 600 that is constructed and arranged to engage or interface with the fastener that extends through opening 52 of adjuster 50 to enable adjuster 50 to be guided by and rotatable about the fastener, i.e., about axis B-B during the installation of tensioner 100. Fastener engaging member 600 extends from, and is integral with, leg portion 591 and includes a body section that extends longitudinally and substantially perpendicular to plate portion 56 and parallel to axis B-B. A foot 602 extends from the body section in a substantially or generally radially inwardly direction towards the axis B-B so as to engage or interface with the fastener inserted into opening 52 of arm 50 for installation of tensioner 100. Fastener engaging member 600 may be substantially or generally L-shaped as illustrated, but may form any other suitable shape that enables member 600 to engage the fastener and ensure that the fastener, when inserted into arm hole 52, stays substantially perpendicular to plate portion 56 and parallel to the pulley rotational axis C-C and to the arm rotational axis (not labeled) for proper installation of tensioner 100. Foot 602 may include a distal or toe end 604 that is configured to engage or interface with the fastener inserted into the opening 52 of arm 50. In the illustrated embodiment, engaging surface 604a of toe end 604 engages the fastener when the fastener is inserted into the opening 52 of arm 50.

Second guide portion 59b, like first guide portion 59a, further comprises a fastener engaging member 700 that is constructed and arranged to engage or interface with the fastener to enable adjuster 50 to be guided by and rotatable about the fastener, i.e., about axis B-B, during the installation of tensioner 100. Fastener engaging member 700 extends from, and is integral with, leg portion 593 and includes a body section that extends longitudinally and substantially perpendicular to plate portion 56 and parallel to axis B-B (and may extend in substantially the same plane as the body section of fastener engaging member 600). A foot 702 extends from the body section in a substantially or generally radially inwardly direction towards the axis B-B so as to engage or interface with the fastener inserted into opening 52 of arm 50 for the installation of tensioner 100. Fastener engaging member 700 may be substantially or generally L-shaped as illustrated, but may form any other suitable shape that enables member 700 to engage the fastener and ensure that the fastener, when inserted into arm hole 52, stays substantially perpendicular to plate portion 56 and parallel to both the pulley rotational axis C-C and to the arm rotational axis (not labeled) for proper installation of tensioner 100. Foot 702 includes a distal or toe end 704 that is configured to engage or interface with the fastener inserted into the opening 52 of arm 50. In the illustrated embodiment, engaging surface 704a of toe end 704 engages the fastener when the fastener is inserted into opening 52 of arm 50.

Foot 602 and foot 702 together may be angled radially inwardly at an angle, e.g., angled inwardly towards one another, such that that their respective distal or toe ends (and surfaces) form a curvature or arc that interfaces or engages with the curvature or arc formed by the outside surface of the fastener. That is, toe ends 604, 704 of foot 602 and foot 702 may be generally or substantially arcuate or curved to engage with, interface with or substantially conform to the outside surface of the fastener. Foot 602 and foot 702 may form a V-shape when viewed, for example, from a direction looking through opening 52 and parallel to axis B-B towards a distal end of tensioner 100. Together, foot 602 and foot 702 and their respective length, which extend radially inwardly to axis B-B to engage the fastener, allows adjuster 50 to hold the fastener substantially perpendicular to plate portion 56 and parallel to the pulley rotational axis C-C and to the arm rotational axis for proper installation of tensioner 100, i.e., while adjuster 50 is rotated about the fastener.

Forming the adjuster of the present disclosure with first and second guide portions and respective fastener engaging members from a single piece of material allows the adjusters and tensioners of the present disclosure to be easily manufactured with different sized eccentric tensioners and different sized eccentric adjusters. For example, the first and second guide portions and the respective legs of the adjusters disclosed herein may be easily stamped and formed into various sizes and dimensions without requiring serious modification to tools used during manufacturing, thereby enabling the legs to fit into tensioners having sleeves of varying diameters (and hence tensioner pivot arms having center bores of varying diameters). The first and second guide portions and their respective fastener engaging members may likewise be easily stamped and formed into various sizes and dimensions without requiring serious modification to manufacturing tools, enabling the fastener engaging members to engage fasteners of different diameters and allowing the adjusters to be easily manufactured for use with tensioner adjusters of varying eccentricities. In one example, the length of each foot of the fastener engaging members can be easily cut to different lengths and formed so that they may extend to corresponding different lengths radially inwardly, thereby allowing the fastener engaging members to be made so as to engage larger or smaller fasteners and operate with larger or smaller sized eccentric adjusters, e.g., 3 mm, 4 mm or 5 mm eccentric adjusters.

Although a form of the invention has been described herein, it will be obvious to those skilled in the art that variations may be made in the construction and relation of parts without departing from the spirit and scope of the invention described herein.

What is claimed is:

1. A tensioner comprising:
a base;
a sleeve connected to the base, the sleeve having a center bore defined therein;
an arm pivotally engaged with the base about the sleeve;
a pulley journaled to the arm;
a torsion spring engaged between the arm and the base; and
a one-piece eccentric adjuster rotatably mounted within the center bore of the sleeve, the one-piece adjuster comprising:
a plate portion comprising an opening for receiving a fastener for installation of the tensioner,
a first neck portion extending from the plate portion,
a first guide portion extending from the first neck portion, the first guide portion comprising a fastener engaging member constructed and arranged to engage the fastener,
a second neck portion extending from the plate portion on a side of the plate portion opposite from the side of the plate portion from which the first neck portion extends, and
a second guide portion extending from the second neck portion, the second guide portion comprising a fastener engaging member constructed and arranged to engage the fastener.

2. The tensioner of claim 1, wherein (i) the fastener engaging member of the first guide portion extends radially inwardly towards an axis of rotation of the fastener to engage the fastener, and (ii) the fastener engaging member of the second guide portion extends radially inwardly towards an axis of rotation of the fastener to engage the fastener.

3. The tensioner of claim 1, wherein (i) the fastener engaging member of the first guide portion comprises a body extending substantially perpendicular to the plate portion and a foot extending substantially perpendicular to the body of the first guide portion and radially inwardly towards an axis of rotation of the fastener to engage the fastener, and (ii) the fastener engaging member of the second guide portion comprises a body extending substantially perpendicular to the plate portion and a foot extending substantially perpendicular to the body of the second guide portion and radially inwardly towards an axis of rotation of the fastener to engage the fastener.

4. The tensioner of claim 1, wherein (i) the fastener engaging member of the first guide portion is substantially L-shaped to engage the fastener, and (ii) the fastener engaging member of the second guide portion is substantially L-shaped to engage the fastener.

5. The tensioner of claim 1, wherein (i) the first neck portion is substantially U-shaped and comprises a section that is substantially parallel to the plate portion and extends radially inwardly towards an axis of rotation of the fastener, and (ii) the second neck portion is substantially U-shaped and comprises a section that is substantially parallel to the plate portion and extends radially inwardly towards the axis of rotation of the fastener.

6. The tensioner of claim 1, which further comprises a substantially cylindrically shaped bushing positioned between the arm and the sleeve about which the arm is pivotally engaged with the base.

7. The tensioner of claim 1, wherein (i) the first neck portion is substantially U-shaped and comprises a radially inwardly extending section that is substantially parallel to the plate portion, and (ii) the second neck portion is substantially U-shaped and comprises a radially inwardly extending section that is substantially parallel to the plate portion.

8. The tensioner of claim 1, wherein (i) the first neck portion is curved and comprises a parallel section that is substantially parallel to the plate portion and extends substantially radially inwardly, and (ii) the second neck portion is curved and comprises a parallel section that is substantially parallel to the plate portion and extends substantially radially inwardly, and wherein the tensioner further comprises (a) a first reinforcing support that extends from a side of the parallel section of the first neck portion, (b) a second reinforcing support that extends from a side of the parallel section of the first neck portion that is opposite the side of the first neck portion from which the first reinforcing support extends, (c) a third reinforcing support that extends from a side of the parallel section of the second neck portion, (b) a fourth reinforcing support that extends from a side of the parallel section of the second neck portion that is opposite the side of the second neck portion from which the third reinforcing support extends.

9. The tensioner of claim 1, wherein (i) the fastener engaging member of the first guide portion comprises a body extending substantially parallel to an axis of rotation of the fastener and a foot extending from the body of the first guide portion, the body and foot of the first guide portion forming a substantially L-shaped structure, (ii) the fastener engaging member of the second guide portion comprises a body extending substantially parallel to the axis of rotation of the fastener and a foot extending from the body of the second guide portion, the body and foot of the second guide portion forming a substantially L-shaped structure.

10. A one-piece tensioner adjuster comprising:
a plate portion comprising an opening for receiving a fastener for installation of a tensioner;
a first curved neck portion extending from the plate portion;
a first guide portion extending from the first curved neck portion and comprising a fastener engaging member constructed and arranged to engage the fastener;
a second curved neck portion extending from the plate portion on a side of the plate portion opposite from the side of the plate portion from which the first curved neck portion extends; and
a second guide portion extending from the second curved neck portion and comprising a fastener engaging member constructed and arranged to engage the fastener.

11. The one-piece tensioner adjuster of claim 10, wherein (i) the fastener engaging member of the first guide portion comprises a body and a foot extending from the body of the first guide portion radially inwardly towards an axis of rotation of the fastener to engage the fastener, (ii) the fastener engaging member of the second guide portion comprises a body and a foot extending from the body of the second guide portion radially inwardly towards the axis of rotation of the fastener to engage the fastener.

12. The one-piece tensioner adjuster of claim 10, wherein (i) the fastener engaging member of the first guide portion comprises a body and a foot extending from the body of the first guide portion radially inwardly towards an axis of rotation of the fastener, the foot of the first guide portion comprising a toe end to engage the fastener, (ii) the fastener engaging member of the second guide portion comprises a body and a foot extending from the body of the second guide portion radially inwardly towards the axis of rotation, the foot of the second engaging member comprising a toe end to engage the fastener.

13. The one-piece tensioner adjuster of claim 10, further comprising (i) a first reinforcing support that extends from the first curved neck portion, (ii) a second reinforcing support that extends from a side of the first curved neck portion that is opposite the side from which the first reinforcing support extends, (iii) a third reinforcing support that extends from a side of second curved neck portion, (iv) a fourth reinforcing support that extends from a side of the second curved neck portion that is opposite the side of the second curved neck portion from which the third reinforcing support extends.

14. The one-piece tensioner adjuster of claim 10, wherein (i) the engaging member of the first guide portion extends radially inwardly towards an axis of rotation of the fastener to engage the fastener during rotation of the one-piece adjuster, (ii) the engaging member of the second guide portion extends radially inwardly towards an axis of rotation of the fastener to engage the fastener during rotation of the one-piece adjuster.

15. The one-piece tensioner adjuster of claim 10, wherein (i) the fastener engaging member of the first guide portion comprises a body and a foot extending from the body of the first guide portion radially inwardly towards an axis of rotation of the fastener to engage the fastener, (ii) the fastener engaging member of the second guide portion comprises a body and a foot extending from the body of the second guide portion radially inwardly towards the axis of rotation of the fastener to engage the fastener, and (iii) a fastener engaging surface of the foot of the first guide portion and a fastener engaging surface of the foot of the second guide portion forming an arc having a radius of curvature that is substantially equal to a radius of curvature of the fastener.

16. The one-piece tensioner adjuster of claim 10, wherein (i) the fastener engaging member of the first guide portion comprises a body and a foot extending from the body of the first guide portion radially inwardly towards an axis of rotation of the fastener, the foot of the first guide portion comprising a fastener engaging surface constructed to engage the fastener, (ii) the fastener engaging member of the second guide portion comprises a body and a foot extending from the body of the second guide portion radially inwardly towards the axis of rotation of the fastener, the foot of the second guide portion comprising a fastener engaging surface to engage the fastener.

17. A one-piece tensioner adjuster comprising:
a plate portion comprising an opening for receiving a fastener for installation of a tensioner;
a first curved neck portion extending from the plate portion;
a first guide portion extending from the first curved neck portion and comprising a fastener engaging member constructed and arranged to engage the fastener;
a second curved neck portion extending from the plate portion on a side of the plate portion opposite from the side of the plate portion from which the first curved neck portion extends;
a second guide portion extending from the second curved neck portion and comprising a fastener engaging member constructed and arranged to engage the fastener;
a first reinforcing support that extends from the first curved neck portion;
a second reinforcing support that extends from a side of the first curved neck portion that is opposite the side from which the first reinforcing support extends;
a third reinforcing support that extends from a side of the second curved neck portion;
a fourth reinforcing support that extends from a side of the second curved neck portion that is opposite the side of the second curved neck portion from which the third reinforcing support extends; and
wherein the first, second, third and fourth reinforcing supports are arranged to aid in at least reducing deformation of the plate portion resulting from any torque applied to the one-piece adjuster during installation of the tensioner.

18. The one-piece tensioner adjuster of claim 17, wherein (i) the first curved neck portion comprises a parallel section that is substantially parallel to the plate portion, and (ii) the second curved neck portion comprises a parallel section that is substantially parallel to the plate portion, (iii) the first reinforcing support extends from a side of the parallel section of the first curved neck portion, (iv) the second reinforcing support extends from a side of the parallel section of the first curved neck portion that is opposite the side of the first curved neck portion from which the first reinforcing support extends, (v) the third reinforcing support extends from a side of the parallel section of the second curved neck portion, and (vi) the fourth reinforcing support extends from a side of the parallel section of the second curved neck portion that is opposite the side of the second curved neck portion from which the third reinforcing support extends.

19. The one-piece tensioner adjuster of claim 18, wherein (i) the parallel section of the first curved neck portion extends substantially radially inwardly towards an axis of rotation of the fastener, and (ii) the parallel section of the second curved neck portion extends substantially radially inwardly towards the axis of rotation of the fastener.

20. The one-piece tensioner adjuster of claim 17, wherein (i) the first guide portion comprises a first leg and a second leg, the first and second legs of the first guide portion each extending longitudinally from and substantially perpendicular to the plate portion, and (ii) the second guide portion comprises a third leg and a fourth leg, each of the third and fourth legs extending longitudinally from and substantially perpendicular to the plate portion, and which further comprises (a) a first sleeve engaging tab positioned between the first and second legs and arranged to engage a shoulder of a sleeve, and (b) a second sleeve engaging tab positioned between the third and fourth legs and arranged to engage the shoulder of the sleeve, the first and second sleeve engaging tabs cooperating to prevent axial movement of the one-piece adjuster.
